(19) United States
(12) Patent Application Publication
(10) Pub. No.: US 2016/0304088 A1
(43) Pub. Date: Oct. 20, 2016

(54) METHOD FOR CARRYING OUT AN AT LEAST SEMIAUTONOMOUS PROCESS FOR PARKING A MOTOR VEHICLE, PARKING ASSISTANCE SYSTEM, AND MOTOR VEHICLE

(71) Applicant: VALEO SCHALTER UND SENSOREN GMBH, Bietigheim-Bissingen (DE)

(72) Inventor: Harald Barth, Bietigheim-Bissingen (DE)

(73) Assignee: VALEO Schalter und Sensoren GmbH, Bietigheim-Bissingen (DE)

(21) Appl. No.: 15/101,672

(22) PCT Filed: Nov. 13, 2014
(86) PCT No.: PCT/EP2014/074442

§ 371 Date: Jun. 3, 2016

(30) Foreign Application Priority Data
Dec. 5, 2013 (DE) 10 2013 020 315.5

(51) Int. Cl. B60W 30/06

(52) U.S. Cl. CPC B60W 30/06

(57) ABSTRACT

The invention relates to a method for carrying out an at least semiautonomous process for parking a motor vehicle (1) on a road (10) by means of a parking assistance system of the motor vehicle (1), the parking assistance system (2) sensing a dimension of a parking space potentially suitable for the parking process, comparing the sensed dimension with a minimum dimension (19) dependent on a vehicle dimension (20), and carrying out the parking process assuming that the sensed dimension is at least equal to the minimum dimension (19), the parking assistance system (2) sensing a gradient (α) of the road (10) and setting the minimum dimension (19) on the basis of the gradient (α) during operation of the parking assistance system (2).

The invention relates to a method for carrying out an at least semiautonomous process for parking a motor vehicle on a road with the aid of a parking assistance system. The parking assistance system senses a dimension of a parking space potentially suitable for the parking process, and the sensed dimension is compared with a minimum dimension dependent on a vehicle dimension. The parking process is carried out assuming that the sensed dimension is at least equal to the minimum dimension. The invention also relates to a parking assistance system which is designed to carry out such a method and to a motor vehicle having such a parking assistance system.

Parking assistance systems or driver assistance devices which assist the driver of a motor vehicle when carrying out parking processes are already known from the prior art. In this respect, a distinction is made between so-called semiautonomous (semiautomatic) systems, on the one hand, and fully automatic systems, on the other hand. In this case, the common feature of all systems is that a potential parking space is detected and a dimension of the parking space is sensed and is then compared with a stored minimum dimension. If the sensed dimension of the detected parking space is at least equal to the minimum dimension, the possibility of the parking process is signalled to the driver. The system then determines the current relative position of the motor vehicle with respect to the parking space and calculates a parking course (parking trajectory), along which the motor vehicle can be parked in the parking space without a collision. In the case of semiautonomous parking assistance systems, the driver is assigned the tasks of accelerating and braking. In the case of semiautonomous parking assistance systems, the longitudinal guidance of the motor vehicle is therefore controlled by the driver himself, whereas the transverse guidance is controlled by the parking assistance system itself by emitting corresponding control signals to a steering apparatus of the motor vehicle. In contrast, in the case of fully automatic parking assistance systems, both the longitudinal guidance and the transverse guidance are automatically carried out by the parking assistance system by emitting corresponding control signals both to the steering apparatus and to a drive train and a braking system of the motor vehicle. In the case of fully automatic systems, the driver only needs to enable the parking process and can also interrupt it at any time.

A parking assistance system is known, for example, from the document WO 2008/055567 A1.

Ultrasonic sensors which are fitted to the respective side edges in the front region of the motor vehicle are usually used to sense parking spaces. While the motor vehicle moves past a potential parking space, the ultrasonic sensor continuously measures the lateral distance between the motor vehicle and obstacles or objects outside the vehicle. The dimension of the parking space in the longitudinal direction of the motor vehicle and in the longitudinal direction of the road and the relative position of the parking space with respect to the motor vehicle can then be determined on the basis of the progression of the measured values from the ultrasonic sensor and taking into account the distance covered. This applies both to parallel parking spaces, the longitudinal axis of which is oriented substantially parallel to the road, and to perpendicular parking spaces, the longitudinal axis of which runs perpendicular or at an acute angle to the road. Such a detection method is known, for example, from the document EP 0 305 907 B1.

A method for assisting a process for parking a vehicle in a parking space is also known from the document EP 2 161 173 B1. In this case, the course of a lateral boundary of the parking space is determined, in which case, after the vehicle has reached its parked position in the parking space, the steering of the vehicle is automatically moved into a parking position which is stipulated such that the vehicle follows the course of the lateral boundary during a forward or reverse movement starting from its parked position. This parking position of the steering is provided, for example, for the purpose of preventing the parked vehicle from rolling away on an incline. An acceleration sensor in the form of an inertial sensor can be used to sense the vehicle inclination.

The object of the invention is to show a solution for how the at least semiautonomous parking process can be carried out in a particularly safe and situation-dependent manner in a method of the generic type mentioned at the outset.

According to the invention, this object is achieved by means of a method, by means of a parking assistance system and by means of a motor vehicle having the features according to the respective independent patent claims. The dependent patent claims, the description and the figures relate to advantageous embodiments of the invention.

A method according to the invention is used to carry out an at least semiautonomous process for parking a motor vehicle on a road with the aid of a parking assistance system of the motor vehicle. The parking assistance system senses a dimension of a potential parking space and compares it with a minimum dimension dependent on a vehicle dimension. The parking process is only carried out assuming that the sensed dimension is equal to or greater than the minimum dimension. This means, in particular, that the possibility of carrying out the at least semiautonomous parking process is signalled to the driver only when the sensed dimension is at least equal to the minimum dimension. In other words, the potentially suitable parking space is interpreted as a parking space actually suitable for parking only when the sensed dimension is at least equal to the minimum dimension. The invention provides for the parking assistance system to sense a gradient of the road and to set the minimum dimension on the basis of the gradient of the road during operation of the parking assistance system.

Accordingly, the invention proposes the practice of stipulating the minimum required dimension of the parking space (minimum dimension) on the basis of the sensed gradient of the road section on which the motor vehicle and the parking space are situated. As a result, the parking process can be carried out in a particularly safe and situation-dependent manner. In the case of a relatively large gradient, the responsiveness of the driver with regard to acceleration and braking is reduced in comparison with a small gradient. In the case of a relatively large gradient, experience shows that it is considerably more difficult to precisely manoeuvre the motor vehicle. In this case, the method according to the invention proves to be particularly advantageous in semiautonomous parking assistance systems, in particular, in which the steering of the motor vehicle is automatically controlled by the parking assistance system, while the driver is assigned the tasks of accelerating and braking. Even in the case of a steep road, acceleration and braking may be problematic for the driver, to be precise in particular when the distances from the adjacent obstacles are very short. If a larger minimum dimension of the parking space is now assumed for such a steep road, the parking process can be carried out more safely overall since the distances from the obstacles are also greater than in the case of a smaller minimum dimension. Another advantage of the method according to the invention is that the driver is also intuitively provided with the feeling of safe parking, which is also advantageous in the case of fully automatic parking assistance systems. Since more space overall is available for parking, unnecessary interruptions in the parking process by the driver can therefore be prevented. Another advantage is that, as a result of a larger minimum dimension of the parking space, the number of parking moves or steps required for parking can also be reduced in comparison with a smaller minimum dimension, thus also making it possible to reduce the degree of difficulty of the parking manoeuvre.

The parking assistance system is therefore preferably a semiautonomous system which is designed to determine a relative position of the motor vehicle with respect to the parking space, to calculate a parking course for parking the motor vehicle in the parking space without a collision, and, on the basis of this parking course, to emit control signals to a steering apparatus, which control signals cause the steering apparatus to be controlled in such a manner that the motor vehicle is parked in the parking space along the previously calculated parking course without a collision. Acceleration and braking—that is to say longitudinal guidance—are manually controlled by the driver.

Alternatively, however, the parking assistance system may also be a fully automatic system which can also be used to automatically carry out the longitudinal guidance of the motor vehicle.

The current gradient of the road can be sensed, for example, with the aid of a suitable sensor, for example an acceleration sensor. Additionally or alternatively, provision may also be made for the information relating to the gradient of the road to be taken from a digital map on the basis of the current geographical position of the motor vehicle. In this case, a navigation system can be used to provide position signals which characterize the current geographical position of the motor vehicle. This geographical position can then be mapped to the digital map with the aid of a corresponding map matching method, thus determining the position in which the motor vehicle is currently on the map. If the current route section on which the motor vehicle is situated is known, the information relating to the current gradient of the road can then also be read from the digital map for this route section.

Sensing the gradient initially means, in particular, that the absolute value of the gradient of the road is sensed (in percent and/or in degrees). This gradient is preferably measured with respect to the horizontal. The relationship, whereby the greater the gradient of the road, the greater the stipulated required minimum dimension of the parking space, preferably applies.

It proves to be particularly advantageous if the parking process is carried out into a parallel parking space, the main direction of extent or longitudinal direction of which runs parallel to the road. The above-mentioned vehicle dimension, on which the minimum dimension of the parking space depends, is then a length of the motor vehicle measured in the longitudinal direction of the vehicle. The proposed method proves to be particularly advantageous in parallel parking spaces, in particular, since the intention is to manoeuvre the vehicle in a particularly precise manner here in the longitudinal direction of the road.

For the parking process, one embodiment provides for the parking assistance system to check whether the sensed gradient of the road exceeds a predefined threshold value. A constant minimum dimension, which corresponds to that minimum dimension which is otherwise set for a road without a gradient and in the prior art, is preferably set for a gradient below the threshold value. An identical or constant minimum dimension is therefore set for a gradient up to said threshold value. A greater minimum dimension is preferably stipulated only above the threshold value—if the sensed gradient is greater than the threshold value in terms of absolute value—in order to make it possible to safely manoeuvre the motor vehicle.

With regard to the setting of the minimum dimension, the following two embodiments may be provided:

On the one hand, the minimum dimension can be set according to a continuous characteristic curve which indicates the dependence of the minimum dimension on the sensed gradient. The minimum dimension can therefore be set in a particularly fine manner on the basis of the respectively current gradient.

On the other hand, however, provision may be made for the minimum dimension to be set gradually on the basis of the sensed gradient. This means that a single value of the minimum dimension is respectively assigned to at least two value ranges of the gradient. Such a stepped characteristic curve can be implemented without a large amount of effort and also makes it possible to set the minimum dimension in a situation-dependent and needs-based manner on the basis of the sensed gradient.

Optionally, provision may also be made for the parking assistance system to determine whether the parking process needs to be carried out on a downhill or uphill slope. This information can then be taken into account when setting the minimum dimension. In other words, a sign of the gradient is determined by the parking assistance system and the minimum dimension is also set taking the sign into account. This embodiment is based on the knowledge that the longitudinal guidance of the vehicle is easier for the driver when reverse-parking on a downhill slope (the front of the vehicle is higher than the rear) than when the motor vehicle is intended to be reverse-parked on an uphill slope (the rear is higher than the front). When parking on a downhill slope, the driver needs only to reduce the braking force of the motor vehicle under certain circumstances in order to move the motor vehicle into the parking space, whereas the clutch also has to be additionally actuated when parking on an uphill slope, with the result that higher responsiveness is fundamentally presupposed here. With the same absolute value of the gradient, the minimum dimension can therefore be set to be greater for parking on an uphill slope than when parking on a downhill slope.

As already stated, the parking assistance system may be a semiautonomous or else a fully automatic parking assistance system. In this case, all embodiments provide for the practice of carrying out the parking process by means of the parking assistance system to at least comprise determining a relative position of the motor vehicle with respect to the parking space by means of the parking assistance system and determining a parking course along which the motor vehicle can be parked in the parking space without a collision. The motor vehicle is then guided into the parking space in a semiautonomous or else fully automatic manner along the previously calculated parking course. This means that the steering of the motor vehicle is controlled according to the determined parking course.

With regard to the sensing of the dimension of the parking space, provision may be made for this sensing to be carried out by means of a distance sensor of the parking assistance system—for example an ultrasonic sensor—while the motor vehicle moves past the potential parking space. The dimension of the parking space in the longitudinal direction of the road can then be inferred on the basis of the progression of the measured values from the distance sensor and taking into account the distance covered by the motor vehicle.

However, it is also possible to detect the parking space using images from a camera of the motor vehicle and to determine the dimension of the parking space on the basis of these images. In this case, it is also possibly not necessary to move past the parking space.

The invention also relates to a parking assistance system which is designed to carry out an at least semiautonomous process for parking a motor vehicle and comprises means which sense a dimension of a parking space potentially suitable for the parking process, compare the sensed dimension with a minimum dimension dependent on a vehicle dimension, and carry out the parking process assuming that the sensed dimension is at least equal to the minimum dimension. The parking assistance system is also designed to sense a gradient of a road on which the motor vehicle is situated and to set the minimum dimension on the basis of the gradient during operation.

A motor vehicle according to the invention, in particular a car, comprises a parking assistance system according to the invention.

The preferred embodiments presented with reference to the method according to the invention and their advantage accordingly apply to the parking assistance system according to the invention and to the motor vehicle according to the invention.

Further features of the invention emerge from the claims, the figures and the description of the figures. All features and combinations of features mentioned above in the description and the features and combinations of features mentioned below in the description of the figures and/or shown in the figures alone can be used not only in the respectively stated combination but also in other combinations or else alone.

The invention is now explained in more detail using a preferred exemplary embodiment and with reference to the accompanying drawings, in which:

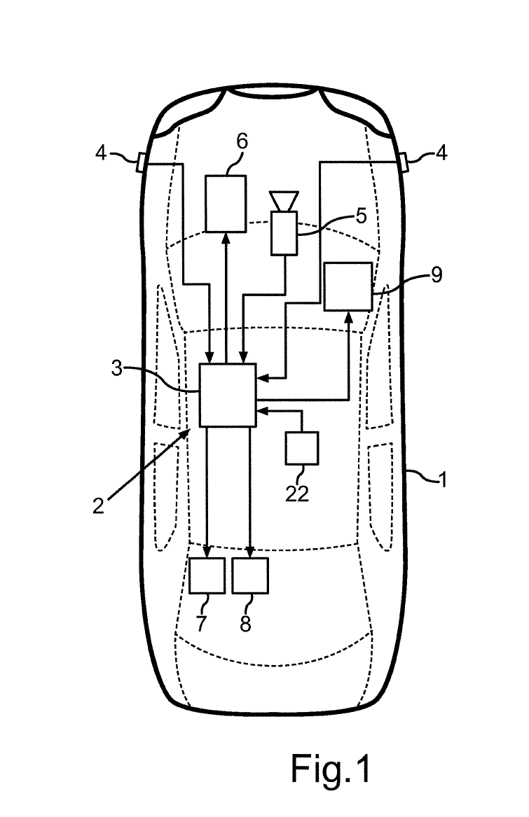

FIG. 1 shows a schematic illustration of a motor vehicle having a parking assistance system according to one embodiment of the invention;

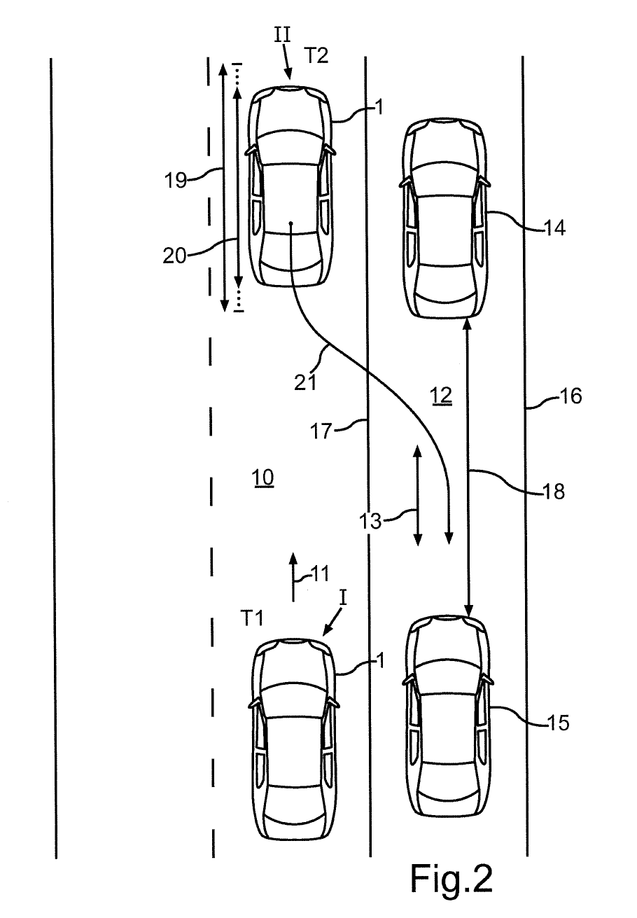

FIG. 2 shows a schematic illustration of a road situation in which an at least semiautonomous process for parking the motor vehicle is carried out;

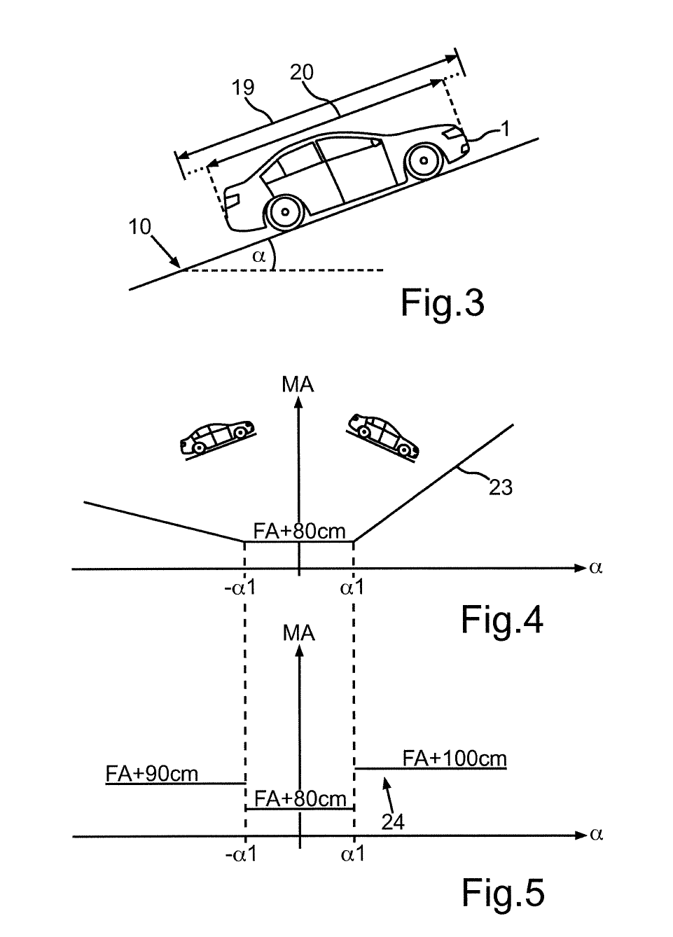

FIG. 3 shows a schematic illustration of the motor vehicle, in which case a method according to one embodiment of the invention is explained in more detail;

FIG. 4 shows an exemplary characteristic curve for setting a minimum dimension; and

FIG. 5 shows an alternative characteristic curve for setting the minimum dimension.

A motor vehicle 1 illustrated in FIG. 1 is a car, for example. The motor vehicle 1 comprises a parking assistance system 2 which is designed to carry out at least semiautonomous processes for parking the motor vehicle 1. The parking assistance system 2 comprises a control device 3 which receives sensor signals from distance sensors 4 which are ultrasonic sensors, for example, and are arranged on respective side edges of the motor vehicle 1, for example in the front region of the motor vehicle 1. Optionally, the control device 3 also receives images or image data provided by a camera 5.

The control device 3 is coupled to a steering apparatus 6 of the motor vehicle 1. The control device 3 can emit control signals to the steering apparatus 6 and can therefore control the steering of the motor vehicle 1 automatically and therefore independently of the driver. In the case of a fully automatic parking assistance system 2, the control device 3 is additionally also coupled to a drive train 7 and to a braking system 8 of the motor vehicle 1 and can then also emit corresponding control signals to the drive train 7 and the braking system 8. In this case, the control device 3 can therefore also control the longitudinal guidance of the motor vehicle 1.

The control device 3 is also coupled to an output device 9 which can be used to output information to the driver. The output device 9 may comprise a loudspeaker and/or a display, for example. The output device 9 can be used, for example, to inform the driver of the fact that a parking space suitable for parking has been detected, and the parking process can therefore be activated by the driver.

According to FIG. 2, the motor vehicle 1 is in a first position I at the time T1 on a road 10, for example an inner-city road with two lanes. The motor vehicle 1 is moving forwards at a relatively low speed in the longitudinal direction of the vehicle according to the arrow illustration 11. Since the current speed is lower than a predefined limit value, the parking assistance system 2 searches for suitable parking spaces for parking.

Beside the road 10, there is a parking space 12 which is a parallel parking space, the main direction of extent 13 of which is oriented parallel to the longitudinal direction of the motor vehicle 1 and parallel to the road 10. The parking space 12 is bounded, in the main direction of extent 13, by a vehicle 14, on the one hand, and by a further vehicle 15, on the other hand. The parking space 12 is laterally bounded by a kerb 16, on the one hand, and by a road marking 17, on the other hand.

The motor vehicle 1 now moves past the potential parking space 12. During this pass-by in which the motor vehicle 1 moves from the position Ito a further position II which is reached at the time T2, the distance sensor 4 senses the lateral distances between the motor vehicle 1, on the one hand, and the vehicles 14, 15, on the other hand. The control device 3 calculates a dimension 18 of the parking space 12 on the basis of a temporal progression of the measured values and taking into account the distance covered between the positions I and II. This dimension 18 is a length of the parking space 12 along the main direction of extent 13.

Additionally or alternatively, the control device 3 can also evaluate the image data from the camera 5 in order to determine the dimension 18.

The dimension 18 is therefore a distance between the two vehicles 14, 15. The control device 3 then compares the sensed dimension 18 with a minimum dimension 19 which depends on a vehicle dimension 20 (here the length of the motor vehicle 1 measured in the longitudinal direction of the vehicle) and is greater than the vehicle dimension 20 by a particular factor. If the control device 3 determines that the sensed dimension 18 of the parking space 12 is at least as large as the minimum dimension 19, the possibility of the parking process is signalled to the driver via the output device 9. The driver can now himself decide whether or not the motor vehicle 1 is intended to be parked in this parking space 12.

The control device 3 also senses the current relative position of the motor vehicle 1 with respect to the parking space 12 and calculates a parking course 21, along which the motor vehicle 1 can be parked in an end position in the parking space 12 starting from the current position II without a collision. If the parking process is activated by the driver, the control device 3 emits control signals to the steering apparatus 6, on the basis of which the motor vehicle 1 is guided along the parking course 21. As already stated, corresponding control signals can also be optionally emitted to the drive train 7 and the braking system 8.

With reference to FIG. 1 again, the parking assistance system 2 comprises a sensor 22 which is used to sense the current gradient a of the road 10. Referring now to FIG. 3, the motor vehicle 1 is on a road 10 which has a gradient α. In order to be able to sense the gradient α, it is possible to use, for example, an acceleration sensor and/or a navigation system. The minimum dimension 19, with which the sensed dimension 18 of the parking space 12 is compared, is set by the control device 3 on the basis of the absolute value of the sensed gradient α during operation. In this case, the sign of the gradient α may optionally also be taken into account, that is to say the information relating to whether the motor vehicle 1 is to be parked on a downhill or uphill slope.

FIG. 4 shows an exemplary continuous characteristic curve 23, according to which the minimum dimension 19 can be set. The minimum dimension is denoted here with MA, the characteristic curve 23 representing a dependence of the minimum dimension MA on the current gradient α. As is clear from FIG. 4, a distinction is made between two situations, namely a first situation, in which the parking process needs to be carried out on a downhill slope (front of the vehicle is higher than the rear of the vehicle) and the gradient a has a negative sign (on the left in FIG. 4), and a second situation in which the parking process needs to be carried out on an uphill slope (front of the vehicle is lower than the rear of the vehicle). A constant minimum dimension MA, which corresponds to the vehicle dimension 20 (denoted with FA in FIG. 4) plus 80 cm for example, is set in a range of values from −α1 to +α1, that is to say when the gradient is below a threshold value α1 in terms of absolute value. If the gradient a exceeds the threshold value α1, the minimum dimension MA is continuously or constantly increased, for example according to a linear function. This function is steeper for parking on an uphill slope and is somewhat flatter for parking on a downhill slope.

Alternatively, the minimum dimension 19 or MA can also be set according to a stepped characteristic curve 24, as is shown in FIG. 5 by way of example. Below the threshold value α1, a constant minimum dimension MA corresponding to the vehicle dimension FA plus 80 cm is set. Above the threshold value α1, a constant minimum dimension MA corresponding to the vehicle dimension FA plus 100 cm, for example, is set. In contrast, if parking is carried out on a downhill slope and the minimum dimension MA is greater than the threshold value α1 in terms of absolute value, it is possible to set a minimum dimension MA corresponding to the vehicle dimension FA plus 90 cm.

1. A method for carrying out an at least semiautonomous process for parking a motor vehicle on a road by a parking assistance system of the motor vehicle, the parking assistance system being configured to carry out the method comprising:
sensing at least one dimension of a parking space potentially suitable for the parking process;
comparing the sensed at least one dimension with a minimum dimension dependent on a vehicle dimension;
carrying out the parking process when the sensed at least one dimension is at least equal to the minimum dimension; and,
sensing a gradient of the road and setting the minimum dimension on the basis of the gradient during operation of the parking assistance system.

2. The method according to claim 1, wherein the parking process is carried out into a parallel parking space, the main direction of extent of which runs parallel to the road, the vehicle dimension being a length of the motor vehicle measured in the longitudinal direction of the vehicle.

3. The method according to claim 1, wherein for the parking process, a check is carried out in order to determine whether the sensed gradient of the road exceeds a predefined threshold value in terms of absolute value, and a constant minimum dimension is set for a gradient below the threshold value.

4. The method according to claim 1, wherein the minimum dimension is set according to a continuous characteristic curve which indicates the dependence of the minimum dimension on the sensed gradient.

5. The method according to claim 1, wherein the minimum dimension is set gradually on the basis of the sensed gradient, with the result that a value of the minimum dimension is respectively assigned to at least two value ranges of the gradient.

6. The method according to claim 1, wherein a sign of the gradient is determined by the parking assistance system and the minimum dimension is also set taking the sign into account.

7. The method according to claim 1, wherein the practice of carrying out the parking process by the parking assistance system at least further comprises determining a relative position of the motor vehicle with respect to the parking space and determining a parking course for parking the motor vehicle in the parking space.

8. The method according to claim 1, wherein the dimension of the parking space is sensed by a distance sensor of the parking assistance system while the motor vehicle moves past the parking space.

9. A parking assistance system for carrying out an at least semiautonomous process for parking a motor vehicle, the parking assistance system being configured to:
sense a dimension of a parking space potentially suitable for the parking process;
compare the sensed dimension with a minimum dimension dependent on a vehicle dimension;
carry out the parking process assuming that the sensed dimension is at least equal to the minimum dimension, and
sense a gradient of a road on which the motor vehicle is situated and to set the minimum dimension on the basis of the gradient during operation.

10. A motor vehicle having a parking assistance system according to claim 9.
